(19) United States
(12) Patent Application Publication
(10) Pub. No.: US 2011/0010306 A1
(43) Pub. Date: Jan. 13, 2011

(54) Educational Information Management System and Education Recommendation Generator

(76) Inventors: Daniel P. Gonzalez, Pittsburgh, PA (US); Eloisa Marquez-Gonzalez, Pittsburgh, PA (US)

Correspondence Address: COOPER & DUNHAM, LLP, 30 Rockefeller Plaza, 20th Floor, NEW YORK, NY, 10112, US

(21) Appl. No.: 12/832,573

(22) Filed: Jul. 8, 2010

Related U.S. Application Data
(60) Provisional application No. 61/223,887, filed on Jul. 8, 2009.

(51) Int. Cl. G06Q 50/00; G06Q 10/00

(52) U.S. Cl. 705/326

(57) ABSTRACT

The present invention contemplates an educational system of improved data collection and management and for providing automated, individually customized, real-time recommendations, comprising: creating a student profile; inputting data relating to a student; inputting data relating to students biographical information; entering data relating to the subjects taken by a student; entering learning objectives for each subject; entering data relating to learning objectives for a subject; entering the importance of each learning objective; entering the correlation between objectives in different courses; entering data relating the students performance in learning objectives; creating a solution profile; inputting data relating to solutions into a solution profile; entering data relating to the learning objectives met by a solution; entering data relating to how effective the solution is at meeting a given learning objective; assigning a score to each learning objective based on the student data and solution effectiveness; calculating the effectiveness of a solution; sorting solutions based on effectiveness for the student; filtering solutions based on non-academic data; and displaying the solutions.

This application claims the benefit of U.S. Provisional Patent Application No. 61/223,887, filed on Jul. 8, 2009, the entire contents of which are incorporated by reference.

### FIELD OF THE INVENTION

The present disclosure relates generally to the field of education systems, and more particularly, to a system of improved data collection and management and for providing automated, individually customized, real-time recommendations to users.

### BACKGROUND OF THE INVENTION

By almost any measure, students in the United States are not performing to their potential. One out of four students drops out of high school. Three out of five students cannot read or perform math at the appropriate grade level. Test scores are down both locally and globally. The United States ranked 17^{th} out of 30 industrialized countries tested in science, 24^{th} in mathematics, and 19^{th} in reading. Students must get more from their educations in order to remain competitive in today's global marketplace.

It has been shown that student performance improves with individualized attention. However, the already overloaded system makes resources for such individualized attention scarce. Thus, the mountain of data existing for each student, as well as teaching tactics and other educational solutions, goes unused. Automated systems can be used to help deliver these resources.

Currently, data regarding students and educational resources exists in disparate locations, including educational organizations and households. Educational organizations are organizations that educate or evaluate students, such as pre-elementary, elementary, primary, secondary, and post-secondary schools, groups of schools such as school districts, and standardized testing organizations.

Further, this data may be collected in ways that create redundant, tedious work for administrators, and do not allow for effective use and maintenance. For example, it is not uncommon that records relating to attendance, grades, special education information and parent notifications are maintained in separate notebooks and/or files. Even where electronic systems do exist, the information in each system cannot be integrated or shared among different systems, even at the same institutions. Thus, time and resources are wasted by generating needless extra paperwork or keying information into various systems.

With current systems, information relating to students may be limited by function, and, even though many sources may have valuable information that could assist a student seeking targeted educational solutions, only a select number of users are actually able to provide information relating to students. In order to generate educational recommendations, separate, specific assessments must be given directly to each student. This tedious analysis process limits the frequency that analyses are performed. Further, recommendations comprise only actual educational content, such as course materials, or solutions that are too generalized, which limit the accuracy and effectiveness of the solution.

Accordingly, there is a need for a system that allows for improved data collection and delivers more accurate and frequent recommendations. Such a system must allow data collection and use among disparate sources and systems, deliver targeted recommendations for improving student performance, over the student's entire educational career. The present invention focuses on specific objectives, resulting in highly targeted and useful solutions for groups and individual students. The present invention allows for the collection of new types of information, authorizes new classes of information providers, and provides individualized recommendations across an array of students. It also provides real-time recommendations that include pointers to educational content offered by outside systems, as well as actual educational content. Additionally, recommendations are updated and refined using crowd-sourcing techniques, and an individualized assessment develops over the student's entire educational career as users interact with the system.

### SUMMARY OF THE INVENTION

To these and other ends, the present invention contemplates an educational system of improved data collection and management and for providing automated, individually customized, real-time recommendations, comprising: creating a student profile; inputting data relating to a student; inputting data relating to students biographical information; entering data relating to the subjects taken by a student; entering learning objectives for each subject; entering data relating to learning objectives for a subject; entering the importance of each learning objective; entering the correlation between objectives in different courses; entering data relating the students performance in learning objectives; creating a solution profile; inputting data relating to solutions into a solution profile; entering data relating to the learning objectives met by a solution; entering data relating to how effective the solution is at meeting a given learning objective; assigning a score to each learning objective based on the student data and solution effectiveness; calculating the effectiveness of a solution; sorting solutions based on effectiveness for the student; filtering solutions based on non-academic data; and displaying the solutions.

### BRIEF DESCRIPTION OF THE DRAWINGS

Further features and advantages of the invention will become apparent upon review of detailed description of the preferred embodiments taken in conjunction with the drawings, in which:

FIG. 1 is a flow chart of top level process flow for the educational recommendation generator of the present invention;

FIG. 2 is a flow chart illustrating sources of student information for use in the educational management system of the present invention;

FIG. 3 is a flow chart showing collections of solution information from various sources;

FIG. 4 is a flow chart showing the method of analyzing student information;

FIG. 5 is a flow chart for analyzing solution information;

FIG. 6 is a flow chart showing a method for matching student information with solution capabilities; and

FIG. 7 is a schematic diagram showing an apparatus including a computer system for implementing the educational information management system and education recommendation generator of the present invention.

### DETAILED DESCRIPTION OF THE PREFERRED EMBODIMENTS

The present invention provides tools (in the form of methods and systems) for a system of improved data collection and management and for providing automated, individually customized, real-time recommendations to users. The preferred embodiment contemplates students at the pre-kindergarten, kindergarten, primary, secondary, and post-secondary levels.

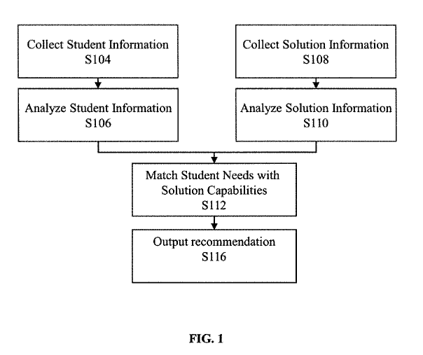

FIG. 1 illustrates the operation of the present invention. The system includes an operation to collect student information (Step S104), an operation to analyze student information (Step S106), an operation to collect solution information (Step S108), an operation to analyze solution information (Step S110), an operation to match student needs with solution capabilities (Step S112), and an operation to provide recommendations to users (Step S116). Data may be continually collected, even while recommendations are being generated.

Users and Privileges

The main types of users or groups of users that will use this invention include: (1) a student, comprising a person who is taking one or more academic courses, has corresponding student information and benefits from recommendations; (2) a parent, comprising a parent, guardian, or any individual who has legal custody of a student or has custodial capacity and is responsible for supervising the student's education; (3) an educator, comprising a teacher, teaching assistant, student teacher, principal, superintendent, guidance counselor, instructor, coach or other employee of an educational organization that has some educational impact on or a legitimate need to interact with educational records for one or more students; (4) a trusted associate, comprising a third party individual who is neither a parent of a student nor directly affiliated with an educational organization, but is trusted and authorized by either a parent or an educator to have information regarding a student's education or has a legitimate need to obtain the student's information, such as tutors, mental health professionals, social workers, and caretakers; (5) a solution provider, comprising individuals or organizations that produce and/or provide social or educational products or services, such as books, software, toys, media, tutoring, counseling, websites, tools, test preparation, and kits; (6) a solution informant, comprising individuals or organizations that provide information regarding solutions, such as solution providers, educators, researchers, educational users, invention administrators, peers of the solution providers, and even members of the general population, for example, retired educators; (7) invention administrator, comprising one or more individuals or organizations that administer the present invention, such as a company; (8) educational organization comprising organizations that educate or evaluate students, such as pre-elementary, elementary, primary, secondary, and post-secondary schools, groups of schools such as school districts, standardized testing organizations such as the Educational Testing Service (which administers the SATs), and the College Board (which develops, publishes, and scores the SATs); (9) households, comprising one or more parents and one or more students, such as a family; (10) a class, comprising one or more students and one or more educators that has a responsibility for educating these students; and (11) educational users comprising parents, students, educators, and trusted associates that use the invention for the purposes of interacting with educational data, oftentimes classroom, student, and school data. Other users are contemplated, for example, clerical users.

Upon access to the terminal using a secure token such as a user name and password, a user inputs and views information appropriate to the user's privilege level. Table 1 describes privilege levels in a preferred embodiment of the present invention. Educators, especially teachers, will have a significant amount of write access, as the classroom management tools provided as a part of the present invention simplify data collection.

Privileges may also vary within user groups. For example, teachers and principals are both educators, but may have different access; tutors and a mental health professionals may also have different access.

TABLE 1
User Privileges

| | Access Level | | | |
|---|---|---|---|---|
| | (read only: RO; read and write: RW) | | | |
| | | | | Trusted |
| Information | Parent | Educator | Student | Associate |
| Demographic data | RO | RO | RO | RO |
| Grades | RO | RW | RO | RO |
| Standards and requirements | RO | RW | RO | RO |
| Special Circumstances | RW | RW | RO | RO |
| Attendance | RO | RW | RO | RO |
| Profile | RW | RW | RW | RW |
| Academic History | RO | RW | RO | RO |

Student Information

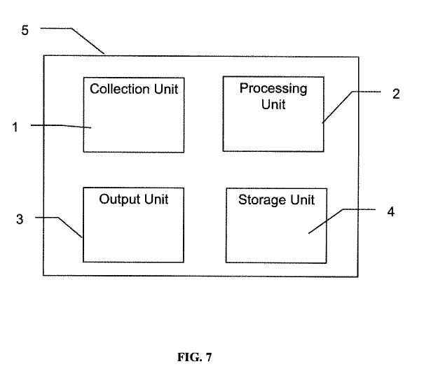

Each student has a profile stored on the storage unit 4 (FIG. 7) that contains information relating to that student. Student information includes information relating to each student possessed by educational organizations and households, and is generally labeled “academic data” and “non-academic data.” Listing 1 below describes student information. Student information includes basic identification information (including but not limited to name, grade, and address), demographics (including but not limited to ethnicity, sex, economic status, and age), individual student needs (including but not limited to students with learning disabilities, gifted students, and students with problems in the home), involvement in extra-curricular activities, student performance (including but not limited to, student grades on a variety of assignments, homework, projects, tests, quizzes, standardized tests, final course grades, class participation, grade point average, and class rank), recommendation history, and educational curricula and courses. Students can be grouped into populations based on student information data. For example, students excelling in certain learning objectives, or students with certain learning disabilities.

Educational curricula (also called courses, subjects or lessons) are created and input into the invention by a number of people and organizations including educators, governments (this includes, but is not limited to, standards such as state standards required by the No Child Left Behind Act and the more recent push in the United States for common standards), parent feedback, and student feedback). Courses comprise one or more learning objectives that students are expected to achieve a certain level of mastery over, and can be taught in various methods, such as by lectures, field trips, and/or audio/video material.

A learning objective is any topic or skill that students are expected to learn in a course. Examples of learning objectives include state standards, common-standards, educator-determined subject matter, and educational organization-level requirements. Students are evaluated against these learning objectives in order to determine their level of performance in a subject. Evaluations include quizzes, tests, exams, assignment grades or similar assessments. Evaluations may be given by educators, governments, or any other educational organization.

Listing 1: Student Information

```
Academic Data
    Courses
      Grades
          Final
          Grading period
          Individual assignment. evaluation, or lesson (homework, projects, quizzes, exams, etc) grades
          Prerequisite course grades
      Learning Objectives
          Government Learning Objectives (standards, laws, regulations, etc)
          School and School District Learning Objectives (district requirements, charter requirements, etc)
          Educator Learning Objectives (syllabus, policies, lesson plans, etc)
          Prerequisite Learning Objectives. Co-requisite Learning Objectives, Post-requisite Learning
          Objectives
          State of Learning Objectives
            Learning Objectives that are expected to be taught in course
            Learning Objectives that have been taught in course
            Learning Objectives that have been evaluated (either directly on assignment, quiz, or exam or by
            Educator through participation or other method)
            Performance against Learning Objectives
        Attendance (time in class)
    Class rank
    Grade point average
    History (Learning Objectives)
    External testing results (standardized tests. SAT, ACT, state evaluations, SRI, etc)
Non-Academic Data
    Demographic Data
        Age
        Sex
        Grade Level (this is academic, too)
        Address (geographic location)
        Ethnicity
  Economic Status
  Extra-curricular activities
  Special circumstances
      Learning disabilities (this is academic, too)
      Difficult home life
      Etc.
  User Preferences
  User History with Invention
  Recommended solutions
  Attempted solutions
  Feedback regarding previously recommended solutions
```

Student Information Collection

With reference to the schematic diagram shown in FIG. 7, student information is entered into the collection unit 1 through a data input terminal that is connected to a network, a LAN, WAN, or the Internet. In addition, student information is generated by the processing unit 2 and added to the student's profile. Student information may be stored on a local database on a remote database that is accessible via the Internet by a web content server.

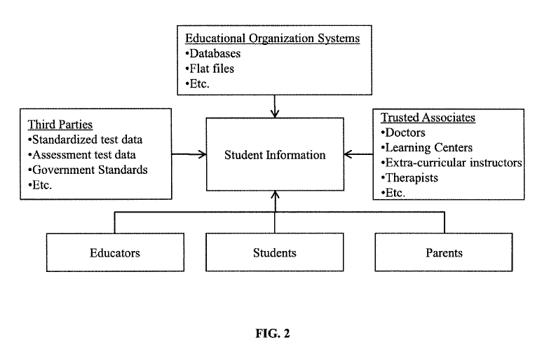

FIG. 2 illustrates sources from which student information is collected in one preferred embodiment. Users enter student information into the collection unit 1 (Step S104). For example, an educator, clerical user, student, or parent is expected to enter appropriate initial or missing demographic data. The present invention provides an interface to enter student information and store it on local or remote computer-readable media such as RAM, CD-ROM, or hard disk. The present invention also provides methods for retrieving previously captured student information from existing data management tools, such as databases, in order to avoid duplicating work.

The system includes various tools that enable efficient management of student information, such as content planning tools to easily plan the structure, content, schedule, and evaluation methods in their course, as well as plan and record all lessons, assignments and evaluations/performance assessments, and associated learning objectives. With respect to evaluation tools, the invention provides grade books, comprising customizable methodologies and schedulers, wherein educators record student grades for all assignments and evaluations that they give to students whether they are formal, such as on an evaluation, or informal, such as occurs with class participation, and grades can easily be associated with learning objectives (assignments are homework, projects, presentations, etc.). The system also provides educational information management modules, which allow educators to track student information, such as attendance and behavior management tools and schedulers, which can be aligned with learning objectives, where appropriate. In addition, there are feedback tools, allowing a student or other user provide feedback regarding a solution attempted by the student or collecting feedback regarding content or activities offered. In this manner, users can provide recommendations to other users.

The present invention combines a school's existing tools and custom modules into an easy-to-use interface. These tools integrate with existing types of educational data management modules and systems, such as databases, in order to retrieve previously captured student information and avoid duplicating work.

The data is collected in a manner that allows the system to provide automatic, individually customized, real-time recommendations for each user in each subject. These tools allow educators to collect information about students needed by the present invention to provide efficient and accurate recommendations. Of course, while not all collected information may be necessary to make a recommendation, more information on which to base an analysis usually results in improved recommendations. Improved data-collecting capabilities result in more accurate recommendations, improved educator performance, and improved administration.

Analysis of Student Information

The student information is analyzed by the processing unit 2 in order to determine a student's strengths and weaknesses, as well as prepare the data to be matched to a solution. Determining a student's strengths and weaknesses involves evaluating a student's performance with respect to each learning objective in each class the student is taking, as well as past academic performance.

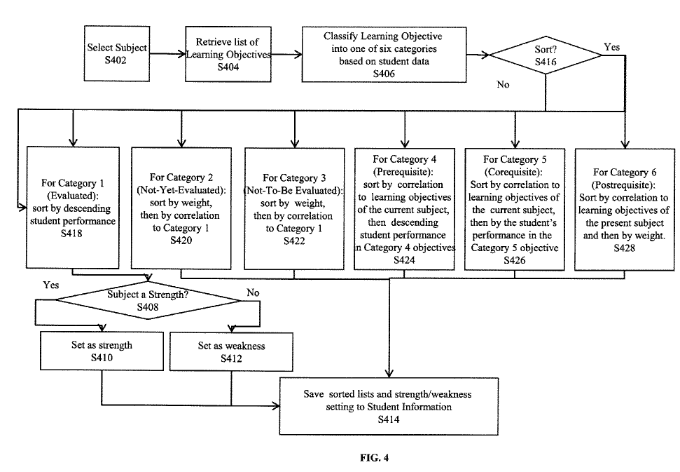

FIG. 4 illustrates the process of analyzing student information. For each subject (Step S402), a list of the subject's learning objectives is retrieved (Step S404). The learning objectives are divided into six categories. The six learning objective categories are: Category 1, objectives that have already been evaluated; Category 2, learning objectives that have not yet been evaluated, but will eventually be evaluated (“Not-Yet-Evaluated Objectives”); Category 3, unevaluated learning objectives that will not be later evaluated (“Not-To-Be-Evaluated Objectives”); Category 4, prerequisite learning objectives; Category 5, co-requisite learning objectives; and Category 6, post-requisite learning objectives.

If the student's performance across all Category 1 learning objectives meets a threshold that is predetermined by parents, educators, or an industry expert-determined default (Yes, Step 408), that subject is classified as a strength (Step S410). Otherwise, it is classified as a weakness (Step S412). Because grading systems used vary across states, districts, school, and classes, the student performance rubric used to sort may be different across educational organizations. There will, however, be a threshold of performance students are expected to meet in order for a subject to be considered a strength. This data is stored to the student profile (Step S414).

Optionally, it may be useful in some applications to sort the objectives in each of the six categories (Yes, Step S416). A sort is conducted in the following manner. Category 1 objectives are sorted based on the student's performance (Step S418).

Category 2 objectives are sorted by weight and then, if the data exists, by correlation to the Category 1 objectives (Step S420). Similarly, Category 3 objectives are sorted by weight and then by correlation to the Category 1 objectives (Step S422). Weight represents an objective's importance; a relatively higher weight means the objective is of greater importance. Correlation represents how relevant one objective is to the other. Weights and correlations have a default value that is predetermined by experts and can be modified by educators.

Category 4 objectives are sorted by correlation to the learning objectives of the current subject, and then in descending order of the student's performance on Category 4 objectives (Step S424). Category 5 objectives are sorted by correlation to the learning objectives of the current subject, and then in descending order of the student's performance on Category 5 objectives (Step S426). Category 6 objectives are sorted by correlation to the learning objectives of the current subject, and then by weight (Step S428). As previously stated, weight represents the objective's importance, correlation represents how relevant one objective is to the other; both are predetermined by experts and can be modified by educators.

All sorts and the strength/weakness value are saved to the student information profile (Step S414).

Solutions and Solution Information Collection

With reference to the schematic diagram shown in FIG. 7, solution information is entered into the collection unit 1 through a data input terminal that is connected to a network, a LAN, WAN, or the Internet. In addition, solution information is generated by the processing unit 2 and added to the solution and/or student profile. Solution information may be stored on a local database on a remote database that is accessible via the Internet by a web content server.

A solution is information about an action that a user can take in order to improve or supplement his or her own performance or the performance of another user or group of users. A solution refers to a social or educational product or service provided by a solution provider, used to improve or supplement academic performance. Solutions may be pointers to social or educational content, information on how to obtain the social or educational content, and actual social or educational content.

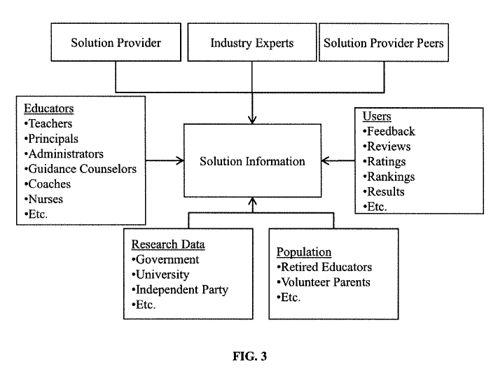

In addition, solution information comprises data shown in Listing 2. Information about the effectiveness of each solution to assist in reaching a learning objective is collected. As shown in FIGS. 3 and 7, upon access to the terminal using a secure token such as a user name and password, a user enters solution information into the collection unit 1 through a data input terminal that is connected to a network such as the Internet. The data is stored locally or on a remote database accessible through the Internet via a web content server. As FIG. 3 illustrates, the present invention can also gather the appropriate information from computer readable media.

Listing 2: Solution information

```
Applicable Subject
Learning Objectives covered
Effectiveness
  Independent research
  Present Invention Administrator research
  Solution Provider Research
  Success rate
    How successful are they and with whom?
      Success rate against individuals Learning Objectives
      Are they successful with entire population or sub-segments?
      Success rate when combined with other solutions
      Other socio-economic considerations such as ethnic, social, gender,
      economic, disability, etc. considerations
    User feedback and rating
Expert feedback and ratings
Price
Geographic areas covered
Time commitment
List of similar solutions and strength of similarity
```

Analysis of Solution Information

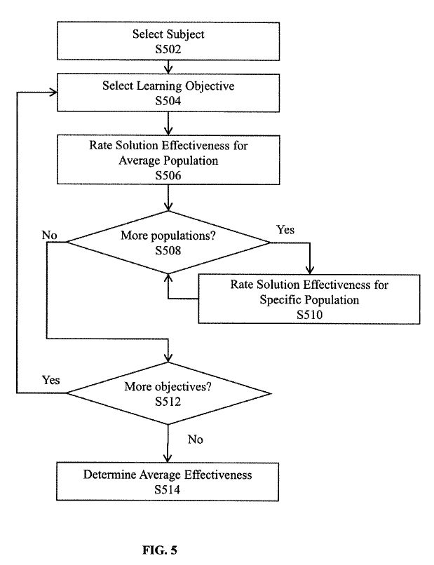

The solution information stored on the storage unit 4 is analyzed by the processing unit 2. FIG. 5. illustrates the process of analyzing solution information. A list of learning objectives for a subject is generated (Step S502). A user rates the effectiveness of a solution in helping an average population meet a given learning objective (Step S506). The user may also rate the solution effectiveness in helping a specific population meet a given learning objective (Yes, Step S508, Step S510). This is performed for all objectives of a given subject (Step S512). For users who belong to multiple populations, a weighted average of effectiveness will be calculated across appropriate populations, and the list will be then sorted by this measure of effectiveness (Step S514).

For example, populations can broad, e.g., all girls, or much more specific, such as fifth grade students. Since students typically belong in multiple sub-segments, e.g., 5^{th} grade girls, the effectiveness can be a weighted average of effectiveness is that calculated across appropriate sub-segments. The effectiveness of a solution among various populations for reaching various learning objectives is maintained in solution data, and a weighted average can be generated for a student or group of students that belong to multiple populations.

Matching Student and Solution Information

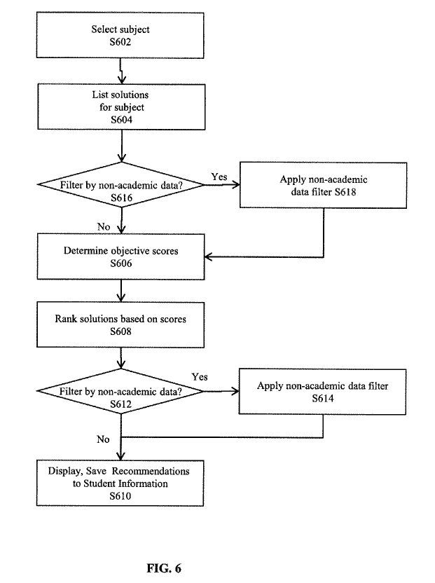

FIG. 6 illustrates the process of matching student information with solution information. The goal is to discover how well a solution will meet the needs of that particular student. Matching may be done at the individual student level, and then aggregated to form a recommendation list for a group of students. The objective is to find the solution that best helps a student or groups of students improve performance on a set of learning objectives. Preferably, analysis is performed routinely over the educational career of a student or group of students. Ideally, the analysis is performed anytime the underlying data changes.

The student and solution information stored on the storage unit 4 is analyzed by the processing unit 2. For each student and subject (Step S602), a list of all possible solutions is generated (Step 604). For each objective addressed by a solution, a score is generated that indicates how well the solution meets the objective in relation to the student (Step S606). The score is determined by adjusting the solution's effectiveness value by the student's specific needs. In order to determine the adjustment value, or weight, student data is examined

The learning objectives of each solution are analyzed based on which objective category they fall under, namely: Category 1, objectives that have already been evaluated; Category 2, learning objectives that have not yet been evaluated, but will eventually be evaluated (“Not-Yet-Evaluated Objectives”); Category 3, unevaluated learning objectives that will not be later evaluated (“Not-To-Be-Evaluated Objectives”); Category 4, prerequisite learning objectives; Category 5, co-requisite learning objectives; and Category 6, post-requisite learning objectives.

Each score for a solution is generated by summing the adjusted effectiveness ratings of each objective addressed by the solution. The objective score for each learning objective is determined in the following manner. Each solution objectiveness rating is multiplied by the performance data, weight and correlation, if such data exists. A relatively high performance value is given where the student did not perform well and needs help with that objective. A relatively low performance value is given where a student performed relatively well. Weight represents how important one learning objective is to another learning objective in the same subject. A relatively high value is assigned where the importance of the objective is relatively high. Weight is a value that is predetermined by experts but may be modified. Correlation represents how important one learning objective is to another learning objective of a different subject. Naturally, for categories 1, 2, and 3, the correlation coefficient must be 1. The correlation coefficient for categories 4, 5, and 6 is a default value or a value that is predetermined by experts, and can be modified. A relatively high correlation value indicates that that the learning objectives are relatively well related.

Solutions are then sorted in the following manner (Step S608). First, the solutions are sorted in descending order based on their Category 1 score. Any solutions with Category 1 scores that differ by less than a value that has previously been determined by experts (but may be modified) (“delta”), are, resorted in descending order according to their Category 2 scores, and then added back to the list.

Any solutions that went through a second sort with Category 2 scores that differ by less than a predetermined value, are resorted in the following manner. If the subject is a strength, then the solutions are sorted in descending order according to their Category 3 scores. Any solutions with that went through the third sort and have Category 3 scores that differ by less than a previously determined value, are sorted in descending order according to their Category 6 scores. Any solutions that went through the fourth sort and have Category 6 scores that differ by less than a previously determined value are sorted in descending order according to their Category 5 scores. Any solutions that went through the fifth sort and have Category 5 scores that differ by less than a previously determined value are sorted in descending order according to their Category 4 scores.

If the subject is not a strength, then the solutions are sorted in descending order according to their Category 4 scores. Any solutions that went through the third sort and have Category 4 scores that differ by less than a previously determined value are sorted in descending order according to their Category 5 scores. Any solutions that went through the fourth sort and have Category 5 scores that differ by less than a previously determined value are sorted in descending order according to their Category 3 scores. Any solutions that went through the fifth sort and have Category 3 scores that differ by less than a previously determined value are sorted in descending order according to their Category 6 scores. The sorted solution list may then be displayed and saved to the student profile (Step S610).

The purpose of the specific sorting procedure is to allow students who are strong in a subject to be presented with recommendations that lead them to work ahead and/or see material that is relevant for the subject but will not be taught to the class as a whole. Students who are weak in the subject are presented with recommendations for improving the prerequisite and co-requisite learning objectives as well as improving the learning objectives in which they are currently weak.

At various points in the process, a filter can be applied to remove solutions from the final solution list. Non-academic student data is used to perform this filtering. Since accurate filtering is critical, it is preferable to apply non-academic filters later in the process (Yes, Step S612, S614). However, for example, where it is essential to remove solutions outside the student's geographic location (Yes, Step S616), this filter may be performed as an earlier step of the matching process (Step S618). If a geographic restriction is not a critical characteristic of the solution, it may be performed later (Step S614).

A further example would be waiting to see how a particular solution scores for a student before filtering it based on price. If it is a highly effective yet expensive solution, it may be worth review. Conversely, if a solution is very expensive and appears to be relatively ineffective for a student, it can be removed from the list. Other non-academic filtering options include removing solutions that take will take too much time to perform considering a student's involvement in extra-curricular activities; removing prohibitively expensive solutions; and removing solutions that have a poor success rate for a student with a particular dataset, such as a particular learning disability.

Providing Recommendations

Recommendations are the top-ranking solutions. The processing unit 2 selects and transmits the top scoring recommendations to the output unit 3. There are multiple ways to display the recommendations. Should more than one recommendation be provided, a table can be provided for each subject that allows the educational user to sort recommendations by non-academic filters such as price, effectiveness, time required, user ratings, etc.

Multiple recommendations for multiple subjects can be shown to an educational user. If the educational user is seeking recommendations that pertain to multiple students, lists of potential solutions are generated for each student and the data is aggregated. The solutions that score the highest for the largest number of students in a class are recommended. This aggregation will be useful for educators who have more than one student in a class and parents with multiple students, although this is only an example and not intended to limit the scope of the present invention.

All users have access to recommendations. In order to maintain privacy, privilege levels relating to viewing recommendations pertaining to a specific individual or group of specific students are instituted in the preferred embodiment of the present invention. For example, while students can only view their personalized recommendations, parents, educators, solution providers, and trusted associates can view the recommendations for themselves as well as for the students for whom they are responsible.

Parents can view recommendations for their children who are students. These recommendations will allow parents to better help their student children.

Students can view recommendations for themselves. Educators cannot always provide students with the individual attention they need. The ability for a student to quickly and easily see their strengths and weaknesses and be informed of subsequent steps they can take on their own with, or without, educator intervention is extremely powerful and will allow students to improve the quality of their educations on their own.

Educators can view recommendations for individual students as well as classes. Educators will be informed of methods that students can take to improve or supplement their skills. Class-level recommendations provide educators with steps they can take to improve or supplement the skills of the class as a whole. Educational organization-level recommendations provide educators with steps they can take to improve or supplement the skills of the students in the educational organization as a whole. Educators can modify or create recommendations.

Types of educators other than teachers will find recommendations useful as well. For example, guidance counselors will be able to monitor student performance and make suggestions as to how they might improve or what steps they can take to better their chances for attending college.

FIG. 7 illustrates the components of the a system of improved data collection and management and for providing automated, individually customized, real-time recommendations to users 7, comprising a computer system having an input portion 1 for collecting information, a processing unit 2 for processing information, an output unit 3, for outputting information, and a storage unit 4 for storing information. The information may be inputted into a computer through a keyboard or other means including a scanner, data transmission module or the like, or may be downloaded from a network or the Internet. It may be stored on one or more local or remote hard drives or other storage media, including CDs. DVDs, floppy disks, tapes, or other known storage systems, either on or off-site. For example, there can be provided a personal computer or series of computers, depending on the size of the data pool, number of users, and other variables. Information such as standardized test scores, grades, psychological evaluations and tests, and other information may be stored as part of the record for a particular student, for use in analyzing the student's needs, as well as the needs of larger groups including based on the class, age group, grade, school, school district, or other screen or analysis based upon selected criteria to determine performance, improvement, deficiencies, problems and other issues.

The present invention contemplates a system of improved data collection and management, and for providing automated, targeted, real-time recommendations to users. An improved method of collecting data is contemplated for both student data and solution data. The benefits of improved data collection and management include: (1) allowing educators to quickly and easily monitor student, class and other educational information; (2) allowing users to access information from any computer that is connected to a network or the Internet; (3) allowing educators and relevant third parties to share information with one another through a network, printed reports, or a shared computer terminal; (4) allowing parents or guardians to monitor their student's progress at school; and (5) allowing parents, educators and trusted associates to exchange student information.

Benefits of providing automated, individually customized, real-time recommendations to users include: (1) allowing educators to refine their teaching strategies and enable superior academic performance of their students; (2) enabling educators to inform themselves of the most effective products or services available for their students, classes, or educational groups; (3) informing parents of appropriate steps they or their children can take to help their children improve their performance; (4) informing students of appropriate steps to take to improve their performance; and (5) informing trusted associates of appropriate steps they or their students can take to help their students improve their performance. Recommendations provided by the present invention inform users of educational products and services, and provide a bridge between educational users and solution providers.

Additional benefits of the system include: (1) maximizing usefulness of the large volumes of educational information already collected in the natural course of an educator's work; (2) collecting student-solution and feedback data may be useful to improve the effectiveness of new solutions; (3) the quality of recommendations will be constantly improving as the system processes more and more data over the students' educational careers; (4) reducing administrative work for parents, educators and third parties; (5) delivering targeted, useful recommendations to parents, trusted associates, and students to improve students' performance; (6) involving a student's entire environment in the pursuit of improved educational performance improves the chances of success and reduces the burden on the primary educator; (7) encouraging additional services that include, but are not limited to, translating any or all of the features into a foreign language in order to better inform parents and other users who do not speak the language in which their students are taught; and (8) providing educators with quality tools and a more involved environment; (9) reduced educational costs; and (10) improved communication and feedback across the entire educational system.

Numerous additional modifications and variations of the present invention are possible in view of the above teachings.

1. A method of creating student recommendations comprising:
creating a profile for a student;
inputting data relating to the student;
inputting data relating to the student's biographical information;
entering data relating to the subjects taken by the student;
entering learning objectives for each subject;
entering data relating to the learning objectives for a subject;
entering data relating the student's performance on a learning objectives;
creating a solution profile;
inputting data relating to the solutions into the solution profile;
entering data relating to the learning objectives met by a solution;
entering data relating to how effective the solution is at meeting a given learning objective;
assigning a score to each learning objective based on the student data and solution effectiveness;
calculating the effectiveness of the solution;
sorting a list of solutions based on their effectiveness for the student;
filtering the solutions based on non-academic data; and
displaying the solutions.

2. The method of claim 1, further comprising a method of managing educational information, the method comprising the steps of collecting student data by a data collection unit, storing the data in a storing unit, outputting the data on a data output unit, and collecting Feedback wherein:
one or more users enter data relating to a student into the data collection unit, wherein the users comprise students, parents, educators, trusted associates, solution providers, solution informants, invention administrators, educational organizations, households, classes, and educational users.

3. The method of claim 1, wherein
the student data contains a weight relative to the importance of the learning objective to other learning objective of the same subject, and a correlation value relative to the relationship between one learning objective and a learning objective of another subject.

4. The method of claim 1, wherein:
the solutions receive a rating based on their effectiveness at helping a selected student achieve learning objectives of a specific subject;
the student data contains scores for a student's performance relative to a learning objective, a weight relative to the importance of the learning objective to other learning objective of the same subject, and a correlation value relative to the relationship between one learning objective and a learning objective of another subject;
the learning objectives of a solution receive a score that is the product of the solution's effectiveness rating, the objective's correlation, and the objective's weight;
the solution receives a score that is the sum of the scores of each of its learning objective scores;
solutions are sorted based on their score;
when scores for solutions are within a predetermined value of each other, they are re-sorted according against another category of learning objectives;
the solution list is filtered by defined categories; and
the remaining solutions are displayed.

5. The method of claim 1, wherein the learning objectives are classified as evaluated learning objectives, learning objectives that will not be evaluated, learning objectives that will eventually be evaluated, pre-requisite learning objectives, co-requisite learning objectives, and post-requisite learning objectives based on student data.

6. A method of generating education recommendations using a programmable computer, the method comprising the steps of processing student data in a processing unit of a digital computer, storing the data in a storing unit, and outputting the data on a data output unit, wherein:
one or more users enter data relating to solutions to the data collection unit;
one or more users enter data relating to students to the data collection unit;
the solutions in the data collection unit are sorted by the processing unit in relation to student data; and
the higher ranking solutions are selected by the processing unit for output to the output unit as recommendations for a student or group of students.
